(19) United States
(12) Patent Application Publication
(10) Pub. No.: US 2021/0195459 A1
(43) Pub. Date: Jun. 24, 2021

(54) TECHNIQUES AND ARCHITECTURES OR DYNAMIC DATA DECODING AND CLASSIFICATION UTILIZING EMBEDDED SCRIPTS

(71) Applicant: Hewlett Packard Enterprise Development LP, Houston, TX (US)

(72) Inventors: Ankur Kamthe, Santa Clara, CA (US); Jian Dong, Santa Clara, CA (US); Anuj Bakre, Santa Clara, CA (US); Hao Lu, Santa Clara, CA (US)

(21) Appl. No.: 16/721,366

(22) Filed: Dec. 19, 2019

(51) Int. Cl. H04W 28/02; H04L 12/851

(52) U.S. Cl. CPC H04W 28/0215; H04L 47/2441; H04L 47/2483

(57) ABSTRACT

Techniques and architectures for using embedded scripting to support network device functionality. The format and a content of a network packet is evaluated to determine whether a receiving device is configured to decode the format and content of the network packet. Identification information for the non-classified network device and a payload from the network packet is sent to a remote server device. At least a code segment to enable decoding of the network packet format and content is received from the remote server device. The non-classified network device is classified to result in a classified network device based on decoding of the network packet utilizing the code segment. Data priority tags are applied to device traffic from the classified network device utilizing the code segment.

### TECHNICAL FIELD

Embodiments relate to techniques for detecting traffic from an unknown device, decoding the traffic and handling the traffic with one or more code segments or scripts. More particularly, embodiments relate to techniques for detecting traffic from an unknown device, receiving one or more corresponding embedded scripts and managing tags (and possibly other information) based on the received corresponding scripts to provide integrated network support for the unknown device.

### BACKGROUND

The Internet of Things (IoT) refers to an internetworking of computing devices that can be, for example, mechanical devices, digital devices, electronic objects, etc. IoT devices generally have corresponding unique identifiers (UIDs) and the ability to communicate over a network (wired, wireless or a combination thereof) and are configured to perform a relatively specific set of operations.

IoT devices can cover a range of technologies including, for example, real-time monitoring, real-time analytics, machine learning, environmental sensors, embedded systems, geographical sensors, device control, automation. One use case example can be the concept of the “smart home” ecosystem with an interconnection of lighting control, appliance control, heating, air conditioning and ventilation (HVAC) control, security system and cameras (each having their own sets of protocols, formats and specifications) that can be controlled by a tablet, smart phone or other electronic device.

Because IoT devices within an ecosystem can include many different types of devices, the corresponding providers, protocols and parameters can be diverse and integration of these disparate devices into a seamlessly functioning ecosystem can be complex. Thus, improved techniques and mechanisms to accomplish this would be useful.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a network having multiple embedded wireless devices.

FIG. 2 illustrates one embodiment of a workflow for when an IoT device is not classified and its payload cannot be decoded by the receiving access point.

FIG. 3 is a flow diagram of one embodiment of a process for managing unclassified network packets at a network access point.

FIG. 4 is a flow diagram of one embodiment of a process for dynamically providing network packet handling code to a network access point.

FIG. 5 is a block diagram of one embodiment of packet management agent for managing unclassified network packets at a network access point.

FIG. 6 is a block diagram of one embodiment of an agent for dynamically providing network packet handling code to a network access point.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

The number of Internet of Things (IoT) and Bluetooth Low Energy (BLE) devices being deployed is rapidly growing. These devices include, for example, lighting control or security devices that are deployed in locations often having wireless networks with one or more access points, network controllers and/or other network nodes. Current solutions require support from one or network nodes for full network integration. Thus, integration of the IoT and BLE devices currently requires network infrastructure provider support, which can become unmanageable as the number of supported devices grows. Further adding to this complexity is the potential need for support from the network infrastructure provider for upgrades or revisions to existing devices.

Integration usually involves writing code customized for each supported device (or at least custom code for the device provider/vendor) to parse and/or decode packets from the supported devices. Often traffic is sent to a third party or vendor server for additional support. Thus, the integration process entails at least gathering packet format specifications from the device vendor and integration within the network infrastructure code base with customized code. Often the integration process also includes acquiring one or more supported devices for unit testing and code releases to update the appropriate code bases. This process may be required for each device revision as well as for initial support for a new device or device type.

Another hurdle to device integration is the ability to quickly and accurately identify IoT/BLE traffic and forward that traffic to a third party server (when appropriate) and to propagate any response to the IoT/BLE devices within appropriate timing windows. This problem arises because the wireless access point (AP) is primarily responsible for moving data back and forth for attached wireless clients. Data going to/from wireless clients dominates the network bandwidth that is available to each access point.

Currently, wireless networks are transitioning from IEEE 802.11n to IEEE 802.11ac or IEEE 802.11ax, and the required wired-side network bandwidth for access points has increased (e.g., from 100 Mps to 1 Gps, or higher). This means that IoT/BLE telemetry data streams from new or not-yet-integrated devices can face contention for network bandwidth resources affecting time-sensitive applications, especially ones such as light control that require short latencies because the default data stream has the lowest priority. This problem can be exacerbated at scale in the wired network where, at every hop, the telemetry traffic faces contention with respect to wireless traffic.

The examples that follow are generally presented in terms of IoT devices communicating with an access point over a wireless network connection. However, the techniques described herein are applicable to other configurations as well, for example, BLE devices, Zigbee devices or a combination of IoT, BLE and Zigbee devices.

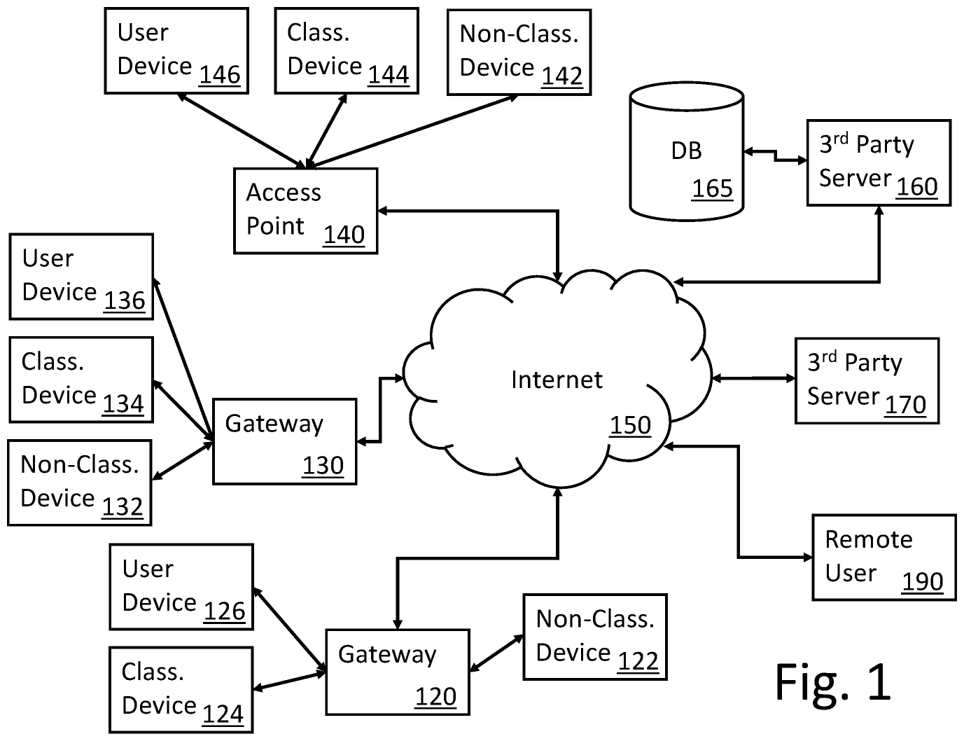

FIG. 1 is a block diagram of one embodiment of a network having multiple embedded wireless devices. The example of FIG. 1 illustrates a simple example for explanation purposes; any number of devices can be supported.

In the example of FIG. 1, Internet 150 (or any wide area network, or WAN) can function to interconnect various devices and services. Any appropriate network communication protocol(s) can be used. Access point 140 can use various wireless and/or wired protocols to provide network access to attached/associated devices (e.g., 142, 144, 146). Access point 140 can utilize, for example, one or more of the IEEE 802.11 family of protocols.

Similarly, gateway 130 can use various wireless and/or wired protocols to provide network access to attached/associated devices (e.g., 132, 134, 136). Gateway 130 can utilize, for example, one or more of the Bluetooth family of protocols. As another example, gateway 120 can use various wireless and/or wired protocols to provide network access to attached/associated devices (e.g., 122, 124, 126). Gateway 120 can utilize, for example, one or more of the Zigbee family of protocols.

In the example of FIG. 1, gateway 120, gateway 130 and access point 140 at least provide access to third party server 160, third party server 170 and remote user 190. Each of gateway 120, gateway 130 and access point 140 can provide network access to various types of devices including, for example, user devices (e.g., 126, 136, 146), classified (or integrated or registered) devices 124, 134, 144) and/or non-classified/unclassified (or non-integrated/unintegrated or non-registered/unregistered) devices (e.g., 122, 132, 142).

User devices (e.g., 126, 136, 146) can be any type of electronic device that can be operated by a user thereof, including, for example, desktop computer, laptop computers, tablets, smartphones, wearable devices. Internet of Things (IoT) devices are generally either classified or non-classified devices as illustrated in the example of FIG. 1. These IoT device can include, for example, real-time monitoring, real-time analytics, machine learning, environmental sensors, embedded systems, geographical sensors, device control, automation devices, radio frequency identification (RFID) devices/tags, electrical systems, embedded audio systems.

With respect to the examples described herein, classified (or integrated or registered) devices are IoT devices that transmit network packets that can be decoded and properly handled by at least one of gateway 120, gateway 130 and/or access point 140. Most of the details and examples that follow are directed to access points; however, the concepts and general functional flow can be applied to gateways as well.

In various embodiments, any number of user devices (e.g., user device 146) can be interconnected to other devices, for example, remote user device 190, third party server 170 through access point 140 using various wireless and/or wired network protocols. Similarly, gateway 130 and gateway 120 can support user devices (e.g., 122 and 132) that operate according to the corresponding protocols, for example, BLE or Zigbee (or any other protocol having a similar architecture).

Various IoT devices can be supported (i.e., classified, registered, integrated) by the hardware, software and/or firmware combination within one or more of gateway 120, gateway 130 and/or access point 140 are capable of decoding network traffic from the supported devices to the extent necessary and the ability to appropriately handle network traffic to and from the supported devices. These are classified devices (e.g., 124, 134, 144). Classified devices may be controlled by a remote user device (e.g., 190), for example. In some embodiments, one or more of the classified devices may access one or more third party servers (e.g., 160, 170). The third party servers may provide information and/or functionality to allow the IoT devices to perform their intended function by utilizing associated databases (e.g., 165) or other resources.

Non-classified devices (e.g., 122, 132, 142) are IoT devices for which the hardware, software and/or firmware combination within one or more of gateway 120, gateway 130 and/or access point 140 are not capable of decoding network traffic from the supported devices to the extent necessary and the ability to appropriately handle network traffic to and from the supported devices. For these non-classified devices, additional support can be provided to allow these devices to become classified (or fully supported) devices. Various techniques to accomplish this are provided herein.

In general, an access point (e.g., 140) receives network traffic from a device, for example, an IoT device, it may utilize a device classifier to determine how to handle the traffic. If the access point cannot classify the network traffic, it can send relevant information (e.g., device MAC address and raw payload) to a remote server for further evaluation. If the remote server recognizes the device or traffic, it can send a script to the access point that allows the access point to properly handle traffic from the new/unknown IoT device.

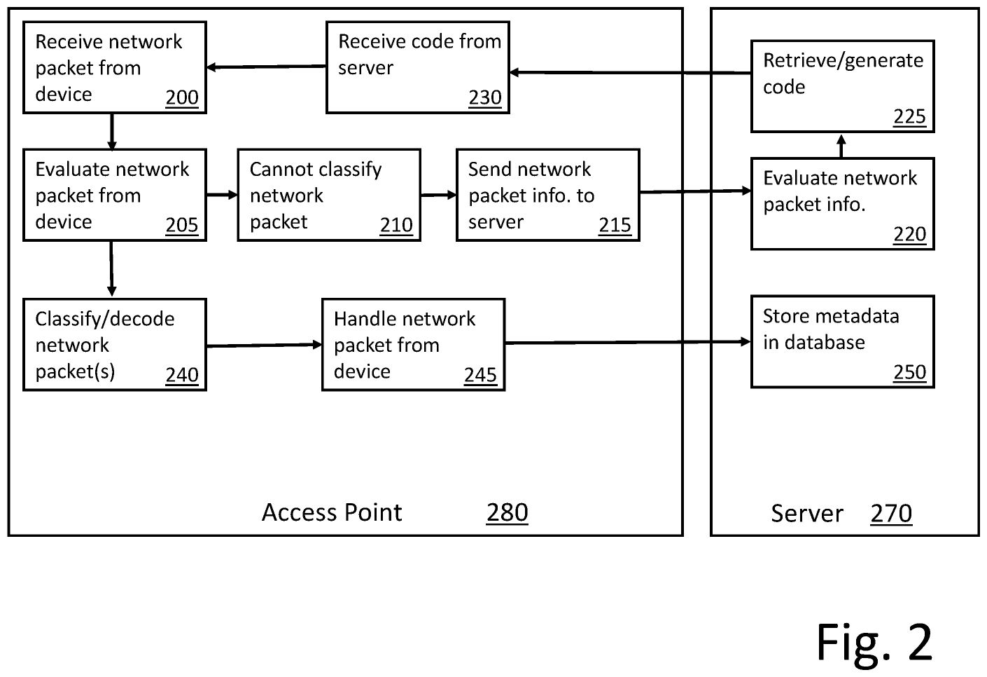

FIG. 2 illustrates one embodiment of a workflow for when an IoT device is not classified and its payload cannot be decoded by the receiving access point. In the example of FIG. 2, server 270 corresponds to a vendor of an unclassified device and is capable of recognizing the device of interest by network packet identifiers, for example, Media Access Control (MAC) address, an Organizationally Unique Identifier (OUI), a processor serial number and/or by decoding the raw payload of the packet when, for example, the server could find some identifier or indication to show that the device corresponds to the vendor.

The MAC address is a unique identifier assigned to a network interface for use in network communications. An OUI is a number that can uniquely identify a vendor, manufacturer or other entity. OUIs are used to uniquely identify a particular piece of equipment through derived identifiers such as MAC addresses, subnetwork access protocol identifiers, etc.

In one embodiment, access point 280 can receive a network packet from a device (e.g., an IoT device), 200. The network packet can be received using wired or wireless network protocols. The source of the network packet can be either a classified device or an unclassified device.

In various embodiments, access point 280 can analyze the network packet, 205, to determine whether the source of the packet is a classified device or an unclassified device. This can be accomplished, for example, utilizing an IoT device classifier within access point 280 (not illustrated in FIG. 2). If access point 280 cannot classify the device (e.g., based on the payload of the packet), 210, then access point 280 can send the packet information, 215, to server 270.

In one embodiment, access point 280 sends a MAC address and the raw payload from the packet to server 270. In alternate embodiments, additional and/or different information can be sent to server 270. In some embodiments, server 270 is controlled/operated/managed by the vendor of the IoT device to be classified. In some embodiments, access point 280 can determine the appropriate vendor for a device based on, for example, an OUI or other identifier in the network packet, or from an analysis of the payload, etc.

In some embodiments, server 270 can receive the information from access point 280. In one embodiment, server 270 can recognize the device generating the network packet by decoding the OUI, packet payload and/or other provided information, 220. Server 270 can then generate (or retrieve) a code segment (e.g., a code blob) to decode and/or handle the network packet, 225.

In one embodiment, the code blob can be encoded as a binary blob. In various embodiments, the code blob can be implemented in a lightweight embeddable scripting language (e.g., Lua). In some embodiments, in the same code blob, the server can embed code to translate the device payload into metadata that can be encoded by the script in an opaque binary format (e.g., Protocol Buffer available from Google).

Server 270 can send, 230, the code blob/script to access point 280 to decode and/or otherwise handle (200, 205) packets from the device, 240. In some embodiments, access point 280 applies data priority tags to traffic from the device, 245, so that traffic is handled appropriately within the network. In some embodiments, server 270 can store device metadata in a database for future processing, 250.

Thus, when access point 280 receives a network packet from the device of interest it can utilize the script to decode the packet contents, 240. Because the script output can be a self-contained opaque binary blob with priority data, network traffic tags stay with device traffic as it flows through the network and access point 280 can place this information in the message body headed for the server. Alternatively, once the network packet is decoded successfully, access point 280 can utilize various datapath technologies to prioritize the IoT device traffic, 245.

In some embodiments, a Differentiated Services Code Point (DSCP)/Dot1p remark can be utilized to change the Internet Protocol (IP) DSCP/VLAN Port Control Protocol (PCP) configuration(s). Also, traffic policies and/or traffic shaping techniques can be used to improve uplink/WAN scheduling. In some embodiments, policy-based routing (PBR) can be used to select better uplink options if multiple uplinks are available.

In some embodiments, with direct access to metadata from the network device server 270 can store device information directly in its database without incurring decoding overhead. In some embodiments, for example, lighting control or asset tracking, this could result in reduced latency.

The techniques and mechanisms described herein provide several advantages over current options. For example, providing the capability to insert code at runtime to parse data packets can reduce dependency on creation of custom code for vendor devices, which results in a more efficient and less expensive development cycle. With the techniques described herein the vendor can subscribe to the telemetry stream from the network infrastructure and provide their own parsing scripts to decode data packets for their devices.

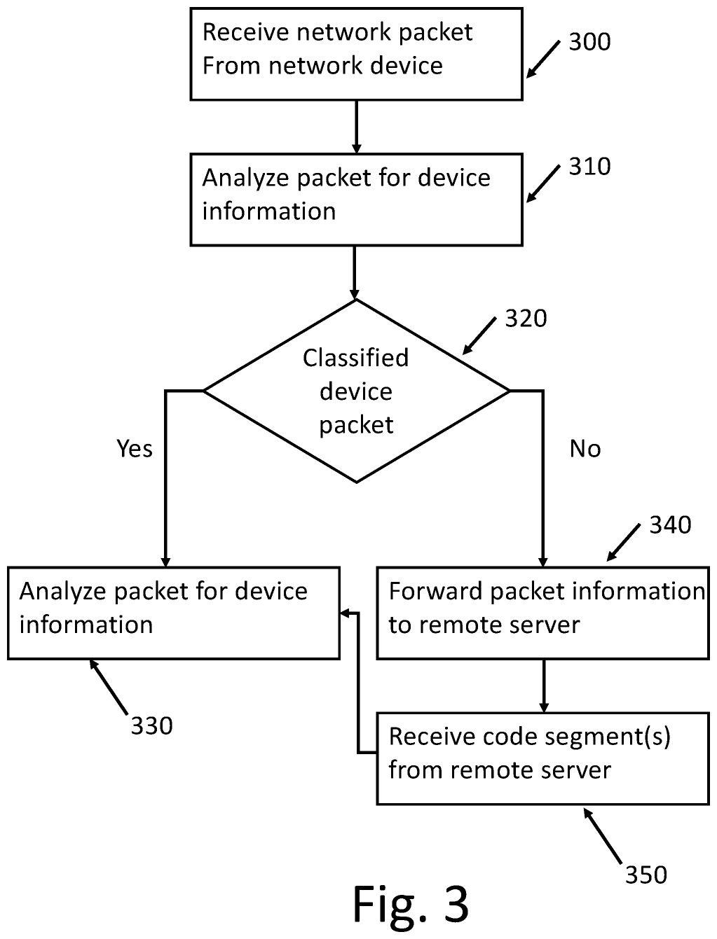

FIG. 3 is a flow diagram of one embodiment of a process for managing unclassified network packets at a network access point. The process of FIG. 3 can be performed by an access point (e.g., 140 of FIG. 1) or other network device providing network access to non-classified devices.

The access point can receive a network packet, 300. The network packet can come from an unclassified/unregistered device, for example, that is not fully supported by the receiving access point and thus is not fully integrated into the network infrastructure.

The access point can analyze the packet, 310, including any information with the packet (e.g., header, payload) or associated with the packet. As a result of analyzing the packet information, the access point can determine whether the packet is a recognized device packet, 320. Recognized device packets are packets for which the access point is configured to support and thus support network traffic from the source device.

If the packet is recognized (i.e., from a classified/registered device), 320, the access point can process the packet using the code and resources available to the access point. If the packet is not recognized, (i.e., not from a classified/registered device), 320, the access point can forward packet information to a remote server, 340.

In various embodiments, identification information for the source of the network packet can be sent to the server. The identification information can include, for example, a MAC address and/or an OUI for the device. In some embodiments, the access point can determine a vendor for the unclassified device from the identification information and the access point can send the identification information to a server corresponding to the vendor. In other embodiments, an identification server can have information for multiple vendors and can determine the appropriate vendor from the identification information.

The access point can receive a code segment from the server, 350, that can be used to process the packet and future packets from the network device, 350. In some embodiments the code received from the server is a script or other lightweight self-contained code segment that is pushed from the server to the access point to allow the access point to fully support (integrate) traffic from the source network device. In some embodiments, this includes a mechanism to tag and/or otherwise prioritize traffic from the source device to provide the appropriate level of network service.

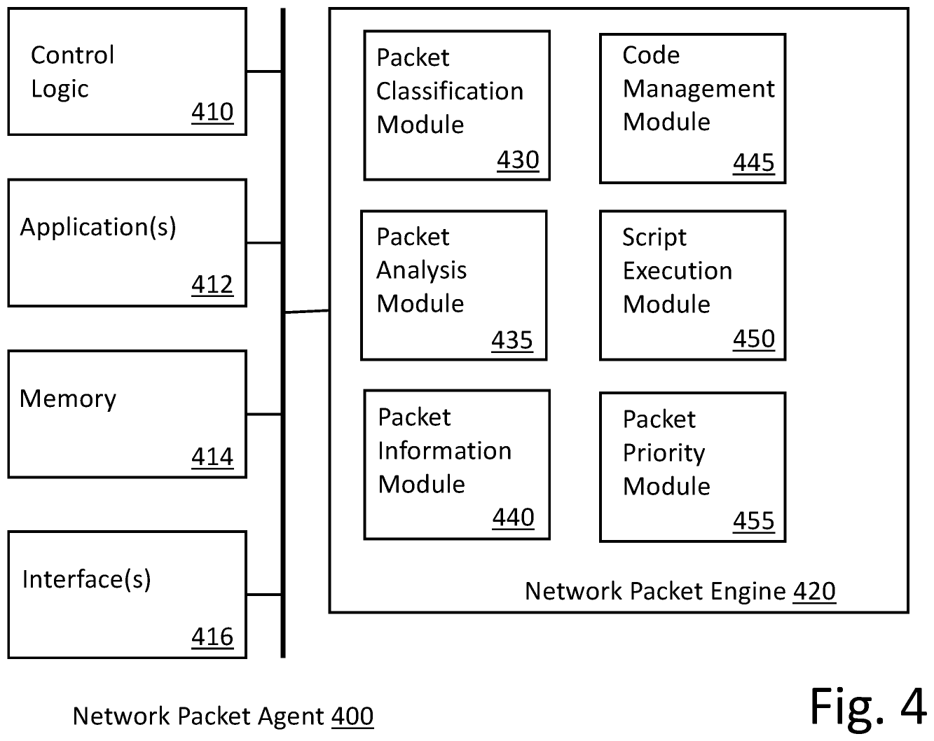

FIG. 4 is a flow diagram of one embodiment of a process for dynamically providing network packet handling code to a network access point. The agent of FIG. 4 may provide functionality as described, for example, with respect to FIGS. 1-3. The agent of FIG. 4 may also provide additional functionality. In one embodiment, network packet agent 400 can reside within a network access point.

In one embodiment, network packet agent 400 includes control logic 410, which implements logical functional control to direct operation of network packet agent 400, and/or hardware associated with directing operation of network packet agent 400. Logic may be hardware logic circuits and/or software routines. In one embodiment, network packet agent 400 includes one or more applications 412, which represent a code sequence and/or programs that provide instructions to control logic 410.

Network packet agent 400 includes memory 414, which represents a memory device and/or access to a memory resource for storing data and/or instructions. Memory 414 may include memory local to network packet agent 400, as well as, or alternatively, including memory of the host system on which network packet agent 400 resides. Network packet agent 400 also includes one or more interfaces 416, which represent access interfaces to/from (an input/output interface) network packet agent 400 with regard to entities (electronic or human) external to network packet agent 400.

Network packet agent 400 also includes network packet engine 420, which represents one or more functions or modules that enable network packet agent 400 to provide the functionality as described above. The example of FIG. 4 provides several modules that may be included in network packet engine 420; however, different and/or additional modules may also be included. Example modules that may be involved in providing the functionality described herein include, for example, packet classification module 430, packet analysis module 435, packet information module 440, code management module 445, script execution module 450 and packet priority module 455. Each of these modules may further include other sub-modules to provide other functions. As used herein, a module refers to routine, a subsystem, logic circuit, microcode, etc., whether implemented in hardware, software, firmware or some combination thereof.

In various embodiments, packet classification module 430 operates to analyze and classify network packets received by network packet agent 400. Packet classification module 430 can determine if a device generating the network packet is fully supported by the access point. Packet classification module 430 can provide this functionality by analyzing, for example, the payload of the received network packet. If the packet cannot be properly handled by the access point, packet classification module 430 can indicate that the packet is from an unclassified (or unregistered or non-integrated) device. If the packet can be properly handled by the access point, packet classification module 430 can indicate that packet is supported and should be handled.

In various embodiments, packet analysis module 435 operates to analyze the network packet to determine a source or vendor of the device generating the network packet. This analysis can be based on, for example, device MAC address, device OUI and/or other identifying information within the network packet.

In various embodiments, packet information module 440 operates to gather information about packets and forward the information to the appropriate remote servers. In some embodiments, packet analysis module 435 or packet information module 440 can determine a manufacturer or vendor for the network device generating the packet. Packet information module 440 can forward the packet information to a server associated with that manufacturer or vendor. In other embodiments, the packet information can be forwarded to another device, for example, a server that supports multiple vendors and further categorizes the packet information.

In various embodiments, code management module 445 operates to receive code segments or scripts from a remote sever. The code can be utilized by the access point to support processing of the network packet as defined or instructed by the manufacturer/vendor. Other third party servers can also provide code if authorized.

In various embodiments, script execution module 450 operates to execute the script pushed by the server to process network packets from the network device. In some embodiments, the process of classifying a packet and receiving code from the server happens in response to the first occurrence of the access point receiving a packet from the device. Until the device is upgraded or some other event triggers the need for updated code.

In various embodiments, packet priority module 455 operates to assign packet priorities based on code executed by the access point. Thus, after receiving the code from the server, the access point can assign the appropriate priority to traffic from the newly registered/classified device.

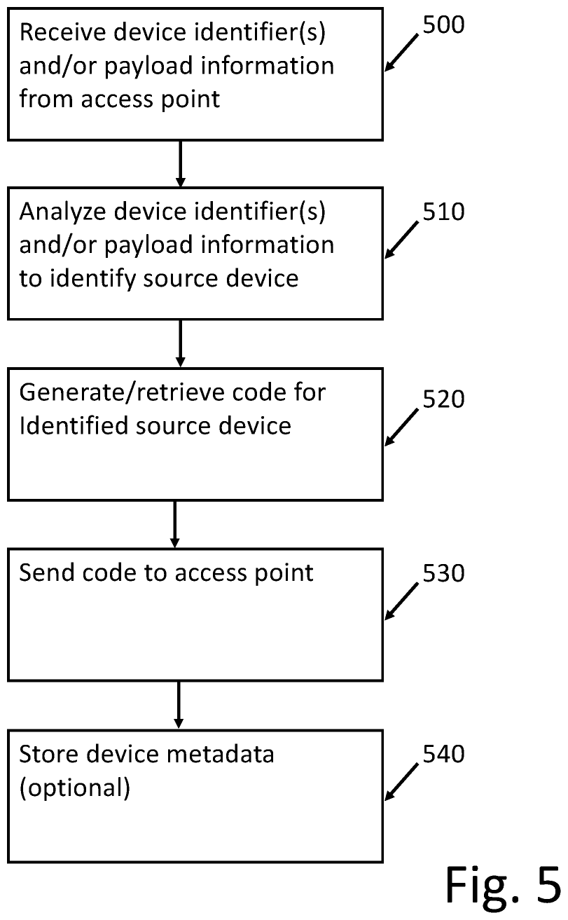

FIG. 5 is a block diagram of one embodiment of packet management agent for managing unclassified network packets at a network access point. The process of FIG. 5 can be performed, for example, by a server belonging to a vendor or other third party (e.g., 160, 170 in FIG. 1).

The server can receive device identifier information and/or payload information from the access point, 500. As discussed above, the device identifier information can be, for example, MAC address, OUI and/or other header information. The payload information can be, for example, the raw payload data or other payload data or information based on the payload.

The server can analyze the device identifier information and/or payload information to identify the source device, 510. The server can, for example, maintain a list of OUIs for all devices manufactured by the vendor with corresponding information, such as, for example, device type, code to be used with the device, registration information, device metadata, etc. The server can also be capable of analyzing the contents of the payload to determine the device type generating the packet. Other identification techniques can also be supported.

The server can generate or retrieve code for the identified device, 520. In some embodiments, the server can maintain a code base with files corresponding to different supported devices. In some embodiments, the server can dynamically generate or update code for the new device. As discussed above, this code a be a lightweight self-contained blob or script that can be executed by the access point.

The code is sent to the access point, 530. Thus, the server determines the code that is needed by the access point to support the device in question and pushes the code to the access point. By doing this the vendor can provide the code necessary for full support/integration into the network infrastructure. This can streamline and simplify the support/integration process.

In some embodiments, the server can store device metadata, 540. This is an optional process that can improve the functionality and overall responsiveness of the new device within the network environment.

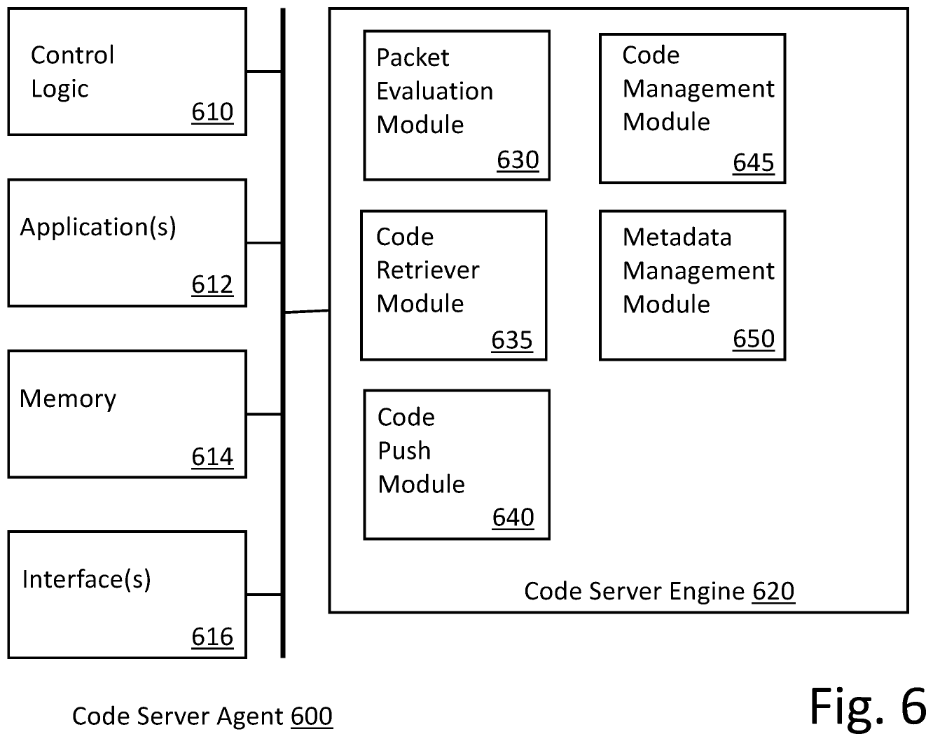

FIG. 6 is a block diagram of one embodiment of an agent for dynamically providing network packet handling code to a network access point. The agent of FIG. 6 may provide functionality as described, for example, with respect to FIGS. 1-3 and 5. The agent of FIG. 6 may also provide additional functionality. In one embodiment, code server agent 600 can reside within a network access point.

In one embodiment, code server agent 600 includes control logic 610, which implements logical functional control to direct operation of code server agent 600, and/or hardware associated with directing operation of code server agent 600. Logic may be hardware logic circuits and/or software routines. In one embodiment, code server agent 600 includes one or more applications 612, which represent a code sequence and/or programs that provide instructions to control logic 610.

Code server agent 600 includes memory 614, which represents a memory device and/or access to a memory resource for storing data and/or instructions. Memory 614 may include memory local to code server agent 600, as well as, or alternatively, including memory of the host system on which code server agent 600 resides. Code server agent 600 also includes one or more interfaces 616, which represent access interfaces to/from (an input/output interface) code server agent 600 with regard to entities (electronic or human) external to code server agent 600.

Code server agent 600 also includes code server engine 620, which represents one or more functions or modules that enable code server agent 600 to provide the functionality as described above. The example of FIG. 6 provides several modules that may be included in code server engine 620; however, different and/or additional modules may also be included. Example modules that may be involved in providing the functionality described herein include, for example, packet evaluation module 630, code retriever module 635, code push module 640, code management module 645 and metadata management module 650. Each of these modules may further include other sub-modules to provide other functions. As used herein, a module refers to routine, a subsystem, logic circuit, microcode, etc., whether implemented in hardware, software, firmware or some combination thereof.

In various embodiments, packet evaluation module 630 operates to evaluate packet information received from the access point. Packet evaluation module 630 can utilize, for example, device identifier information and/or payload information sent by the access point to determine the type of device generating the corresponding network packet.

Code retriever module 635 operates to retrieve or generate code to handle network traffic for the identified device. Code retriever module 635 can retrieve code from a database (e.g., within memory 614) or code retriever agent 635 can dynamically generate code to support the identified device.

Code push module 640 operates to push the code from code retriever module 635 to the access point sending the network packet information. The code pushed to the access point allows the access point to fully support traffic from the corresponding network device.

Code management module 645 operates to manage a code based that can be utilized to support the access points as described herein. Code management module 645 can also be involved in dynamic generation of code to be pushed to the access point.

Metadata management module 650 operates to manage storage of metadata for devices that have been registered/classified by the access point. Thus, metadata management module 650 can function to support operation of the access point and/or the network device after the classification/integration process has occurred.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon instructions that, when executed by one or more hardware processors, are configurable to cause the one or more hardware processors to:
receive a network packet from a non-classified network device, wherein a non-classified network device comprises an network device for which a receiving wireless access point had insufficient information or functionality to decode a payload of the network packet;
evaluate a format and a content of the network packet to determine whether a receiving device is configured to decode the format and content of the network packet;
send identification information for the non-classified network device and a payload from the network packet to a remote server device, wherein the remote server device is selected based on the identification information;
receive, from the remote server device, at least a code segment to enable decoding of the network packet format and content;
classify the non-classified network device to result in a classified network device based on decoding of the network packet utilizing the code segment; and
apply at least data priority tags to device traffic from the classified network device utilizing the code segment.

2. The non-transitory computer-readable medium of claim 1 wherein the identification information for the non-classified network device comprises a hardware address for the non-classified network device.

3. The non-transitory computer-readable medium of claim 1 wherein the code segment comprises a binary code blob.

4. The non-transitory computer-readable medium of claim 1 further comprising instructions that, when executed by the one or more hardware processors, are configurable to cause the one or more hardware processors to send device metadata for the classified network device to the remote server device.

5. The non-transitory computer-readable medium of claim 1 wherein the remote server device is controlled by a vendor of the non-classified network device.

6. The non-transitory computer-readable medium of claim 5 wherein the remote server device dynamically pushes code to handle the traffic from the classified device to the wireless access point.

7. The non-transitory computer-readable medium of claim 1 further comprising sequences of instructions that, when executed by the one or more hardware processors, are configurable to cause the one or more hardware processors to cause device metadata to be stored by the remote server device.

8. A method performed by a network device having at least a memory component and at least one processor coupled with the memory component, the method comprising:
evaluating a format and a content of a network packet received via a network interface to determine whether the network device is configured to decode the format and content of the network packet, wherein a non-classified network device comprises an embedded network device for which a receiving wireless access point had insufficient information or functionality to decode a payload of the network packet;
sending identification information for the non-classified network device and a payload from the network packet to a remote server device, wherein the remote server device is selected based on the identification information;
receiving, from the remote server device, at least a code segment to enable decoding of the network packet format and content;
executing the code segment to classify the non-classified network device; and
applying at least data priority tags to device traffic from the classified network device utilizing the code segment.

9. The method of claim 8 wherein the identification information for the non-classified network device comprises a hardware address for the non-classified network device.

10. The method of claim 8 wherein the code segment comprises a binary code blob.

11. The method of claim 8 further comprising sending device metadata for the classified network device to the remote server device.

12. The method of claim 8 wherein the remote server device is controlled by a vendor of the non-classified network device.

13. The method of claim 12 wherein the remote server device dynamically pushes code to handle the traffic from the classified device to the wireless access point.

14. The method of claim 1 further comprising causing device metadata to be stored by the remote server device.

15. A network access point comprising:
a memory system;
one or more hardware processors coupled with the memory system, the one or more hardware processors configurable to receive a network packet from a non-classified network device, to evaluate a format and a content of the network packet to determine whether a receiving device is configured to decode the format and content of the network packet, to send identification information for the non-classified network device and a payload from the network packet to a remote server device wherein a non-classified network device comprises a network device for which a receiving wireless access point had insufficient information or functionality to decode a payload of the network packet and the remote server device is selected based on the identification information, to receive, from the remote server device, at least a code segment to enable decoding of the network packet format and content, to classify the non-classified network device to result in a classified network device based on decoding of the network packet utilizing the code segment, and to apply at least data priority tags to device traffic from the classified network device utilizing the code segment.

16. The system of claim 15 wherein the identification information for the non-classified network device comprises a hardware address for the non-classified network device.

17. The system of claim 16 wherein the code segment comprises a binary code blob.

18. The system of claim 15 wherein the remote server device is controlled by a vendor of the non-classified network device.

19. The system of claim 18 wherein the remote server device dynamically pushes code to handle the traffic from the classified device to the wireless access point.

20. The system of claim 15 further comprising causing device metadata to be stored by the remote server device.
